(19) United States
(12) Patent Application Publication
(10) Pub. No.: US 2010/0000747 A1
(43) Pub. Date: Jan. 7, 2010

(54) Cookstove fire extinguishing system

(76) Inventor: Joe Dale Reynolds, Katy, TX (US)

Correspondence Address: JOE DALE REYNOLDS, 21326 Park Bend Dr., Katy, TX, 77450, US

(21) Appl. No.: 12/584,631

(22) Filed: Sep. 9, 2009

Related U.S. Application Data
(62) Division of application No. 11/647,055, filed on Dec. 27, 2006.

(51) Int. Cl. A62C 3/00

(52) U.S. Cl. 169/65

(57) ABSTRACT

An improved fire protection system that is of fail safe design for kitchen stoves and other applications utilizing gas for generating heat and in which a fire condition such as a skillet of grease becomes ignited. Said system is activated thermally to release a quantity of fire suppressant material onto the top of the stove quenching the fire while simultaneously cutting off the cooking gas. The system utilizes a reservoir containing the fire suppressant under pressure with a hose or pipe connected to one or more thermally activated spray heads. A second hose or pipe is connected to a pneumatically operated gas cut off valve. The activation of the thermally activated spray head or heads exhausts the pneumatic pressure of the reservoir thereby causing the gas cut off valve to close against the cooking gas.

### CROSS REFERENCE TO RELATED APPLICATIONS

This is a division of application Ser. No: 11,647,055 Filing Date: Dec. 27, 2006 Art Unit 3752

### FEDERALLY SPONSORED RESEARCH

Not Applicable

### SEQUENCE LISTING OR PROGRAMS

Not Applicable

### BACKGROUND OF THE INVENTION

1. Field of Invention

This invention relates to an automatically actuated totally pressurized fire extinguishing system to fit all near wall kitchen stoves with or without a range hood. The invention includes a unique means of automatic shutoff of the heating gas to the stove.

2. Prior Art

The use of automatically activated fire extinguishing devices for cooking stoves is known. Such devices provide a source of fire extinguishing compound to be released on to a stove surface in the event of a fire which occurs during use of the appliance. Virtually all prior art devices are designed and made only for installation within a range hood though preference today often calls for a microwave oven mounted over the cooking stove or such device without a traditional range hood, thereby eliminating the mounting space for the prior art devices.

Even the smallest prior art device installed in a range hood leaves much to be desired in appearance due to the wires, pipes extinguishing nozzles and tanks that can be easily seen by persons near the stove and over time collect unsightly grease and dirt and are difficult to clean.

Prior art automatic fire extinguishing installations sometimes include and automatic shutoff arrangement for shutting off the heating gas to the stove upon detection of a fire. Known shutoff arrangements are generally complex, expensive, and present added components subject to faults and errors in installation and operation. Such devices quite often require professional services such as electricians for their installation, thus this also contributes to onsite installation time and expense.

There is thus a need in the art for a fire extinguishing device which is unobtrusive in appearance, is fail safe, and lends itself to quick and easy installation without the need for professional services.

The following discussed patents are a good representative sample of all prior art patents found.

Prior inventors such as U.S. Pat. No. 4,313,501 to Eckert (1982) have relied on taught wires with fusible disks for their operation under a range hood while the fuel flow to the fire is shut off by a cable arrangement operating through a torturous path to a valve handle. Very little information is provided as to how this is to be done.

Another invention, U.S. Pat. No. 4,979,572 to Mikulec, (1990) again requires a range hood for its operating space and electrical power to the stove is cut off by an arrangement to pull the electrical feed plug from the wall and is activated by a cable means similar to the previously mentioned patent by Eckert. This method was later seen as impractical and was later dropped in a succeeding patent, Mikulec U.S. Pat. No. 5,899,927 (1999), for a much more complicated interruption method. A gas valve for shutting off the gas supply to a gas operated stove is also operated by pulling a cable and releasing a spring powered valve. An alternate method of interrupting the gas supply is offered by Mikulec in U.S. Pat. No. 5,899,927 with an acoustically operated electronic system which introduces more complication and possibility of error unless the owner is well versed in testing and maintenance of the system. Both means of operation require considerable on site labor for both installation, adjustment, and some components could fail during an emergency.

U.S. Pat. No. 5,297,636 by North (1994) Requires a range hood and utilizes a gas valve for gas shut-off that is spring powered and the release of the pressurized gas in the extinguishment tank when released by the activation of a fusible link and operation of a wire that opens a valve to the extinguishment tank provides a puff of pressurized gas from the extinguishment tank that thereby causes the cut-off of the gas valve. The Reynolds gas valve shuts off the gas supply when the pressure from the extinguishment tank is exhausted.

U.S. Pat. No. 4,984,637 by Finnigan (1991) again requires a range hood to hide the mechanism and uses a thermocouple and accompanying electronics to give a temperature display and sound an alarm. A brief mention is made that relays and valves can be used to cut off the stove heating energy. The main emphasis of this patent is that the system will turn off water or other suppressants when the temperature drops. This does not really solve the problem of a grease fire for water is the wrong material to use in such an instance and further the system is intended for a large liquid reservoir system to utilize the cycling on and off.

U.S. Pat. No. 5,127,479 by Sthling et al. (1992) is strictly a range hood system much like the previously mentioned patents by Mikulec which utilizes cables and chain with heat melting links. A 12 volt battery back up system is referred to for powering an undefined valve or relay to cut off gas or electricity to the stove. If the home owner does not check the battery system regularly the system could easily fail to shut off the stove energy source in a fire emergency.

U.S. Pat. No. 5,207,276 by Scofield (1993) operates only with a range hood and utilizes a twisted pair of wires in which the insulation melts to allow the two wires to short. The operation of the system depends on a battery backed up system. Energy cut off to the stove, though critical, is not mentioned.

U.S. Pat. No. 5,868,205 by Cunningham et al. (1999) is designed to be used only with a range hood and has no means to cut off energy to the stove.

U.S. Pat. No. 5,697,450 by Stehling, et al. (1999) is a fully electronic system for a range hood with acoustic triggered cut off of gas or electric energy to the stove. This system is totally dependent on electrical power and is subject to many faults and consequently is not fail safe. Blocking any of the acoustical properties by accumulation of dirt behind the stove by the system could prevent the shut off of energy to the stove.

U.S. Pat. No. 6,044,913 by Stehling et al. (2000) is an electrical system for a range hood fully dependent on battery power and acoustically linked to the energy shut off. This system therefore has the same limitation as U.S. Pat. No. 5,697,450 by Stehling (1999) listed above.

U.S. Pat. No. 6,276,461 by Stager (2001) is a mechanically operated system for a range hood and has no provision for disrupting energy to the stove which could make the system ineffective.

U.S. Pat. No. 3,866,687 Banner 02-1975 Makes reference to operation with or without a range hood. the Banner system applied to a range hood utilizes a pressurized tank with piping to an electrically operated valve with nozzles within the range hood and beneath the burners. The pressurized tank is equipped with a pressure operated meter which is a requirement of approving authority when using unsealed pressurized fire extinguishing tanks. In applying the system to either a range hood or beneath the burner Banner uses electrically operated valves for discharge of the fire suppressant beneath the burners, which might prove less than effective.

U.S. Pat. No. 4,356,870 Gaylord et al. Nov. 2, 1982 System is for range hoods only and utilizes an electrically operated solenoid valve for cut off of the gas and presumably uses an electrically energized relay to cut off the electrical power, which usually requires wiring and electricians. The system utilizes a spray nozzle which is connected to the building water supply and is usually considered to be the wrong material to fight a grease fire.

U.S. Pat. No. 4,830,116 Walden et al. May 16, 1989 System is for range hoods and utilizes electrical equipment to disconnect the power source.

U.S. Pat. No. 5,351,760 Tabor Jr. Oct. 4, 1994 System is for range hoods. Tabor claims the system is pressurized but it is actually pressurized only to an electrically operated release valve adjoining the retardant tank. The spray nozzle of this system is a passive device and is not thermally actuated. Further the spray nozzle has to spray material of a viscosity of one, which is probably water and the nozzle is a cooling spray nozzle of limited capacity usually associated with cooling back porches.

These prior art devices have the disadvantage of being designed only for under or within a range hood even though today thousands of kitchens are designed with a microwave oven with exhaust in place of the range hood. Some require taught wires that require some experience to install and are in a position under a range hood to collect grease and dirt and with such pipes, wires, and other paraphernalia will be difficult to clean. Others rely on electronics for acoustically operating the disruption in electricity or gas and are inherently less reliable than a fail safe system. It must be kept in mind that the average home owner will seldom think of maintenance for such a system and therefore systems of such design can fail long before they are needed in an emergency.

### OBJECTS AND ADVANTAGES

There is a need in the art for a fire extinguishing system which will satisfy the needs of those kitchen type stoves that do not have range hoods and to provide a system that will be of low cost to install, have high reliability, and not require professional services in its installation. Accordingly, several objects and advantages of the present invention are:

(a) to provide a fire extinguishing system for a cooking type stove that is fail safe;

(b) to provide a fire extinguishing system that can be installed without the need for professional services;

(c) to provide a fire extinguishing system that will be versatile and allow installation of components in other than a single type of application;

(d) to provide a fire extinguishing system that can interface with a number of different extinguisher nozzles to meet differing requirements;

(e) to provide a fire extinguishing system in which its cooking gas connection to a stove is a simple screw in pipe connection.

Still further objects and advantages will become apparent from a consideration of the ensuing description and drawings.

### SUMMARY

In accordance with the present invention a fire extinguishing system of fail safe design for kitchen type stoves that not only provides fire sensing and extinguishing but also provides effective disconnection of the energy source for heating and does not require professional services in its installation.

### BRIEF DESCRIPTION OF THE DRAWINGS

For a full understanding of the invention the following detailed description should be read in conjunction with the drawings, wherein:

FIG. 1 is a perspective view of the fire extinguishing apparatus of the present invention applied in this instance to a gas stove without a range hood.

FIG. 2 is a perspective view of the control unit showing its associated parts.

FIG. 3 is a perspective view of the control unit mounted typically in a cabinet.

FIG. 4A is a side view of the pressure operated gas valve.

FIG. 4B is a cross sectional view of the pressure operated gas valve.

FIG. 4C is an exploded view of the pressure operated gas valve.

FIG. 4D is an exposed perspective view of the pressure operated gas valve when sufficient pressure is applied to the piston and the operator is cocked holding the gas valve open to flowing gas.

FIG. 4E is an exposed perspective view of the pressure operated gas valve when pressure on the piston is exhausted and the operator is released causing the closing of the gas valve.

### DETAILED DESCRIPTION OF THE PREFERRED EMBODIMENTS

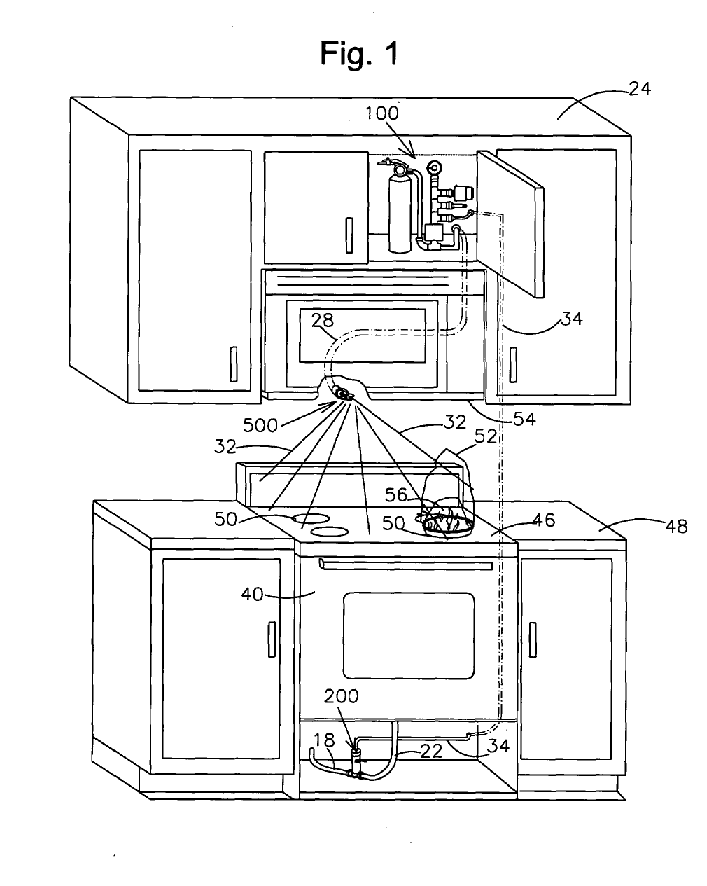

The preferred exemplary embodiments of the invention are illustrated in FIG. 1 through FIG. 4E wherein like numerals represent like parts. In the drawings, closely related figures have the same number but different alphabetic suffixes. Each segment of the system is discussed in detail individually.

A preferred embodiment of the complete system in FIG. 1 for application to a gas stove 40 without a range hood but with a microwave oven 54 is illustrated with the control unit 100 located in a cabinet 24 and connected by high pressure hose or pipe 34 to a pressure operated gas cut off valve 200 which receives the flammable gas by means of a supply line 18 and passes the gas through to the stove burners 50 by means of a supply line 22.

Fire suppressant under pressure is incorporated in the said control unit that supplies pressurized gas and extinguishment to a thermally actuated spray head 500. The said control unit may be mounted in a cabinet over the said stove 24 FIG. 1 or any near by space within an engineer approved distance. Said hoses or piping would be generally installed inside the wall space on both existing and new construction.

In the event of a skillet or other container 56 being left on the said stove and becoming overheated a fire 52 will soon result activating the said spray head thereby releasing the pressurized extinguishing agent 32 in the hoses or piping and originating in the said control unit spraying the top 46 of said stove, thereby extinguishing said fire. The resulting loss of pressure within the system releases a latching device in said gas valve cutting off the flow of cooking gas to the said stove thereby removing the source of the heat to the skillet. The loss of pressure also causes an alarm pressure operated switch 400 to activate switches to transmit an alarm to a local panel or remote monitoring station.

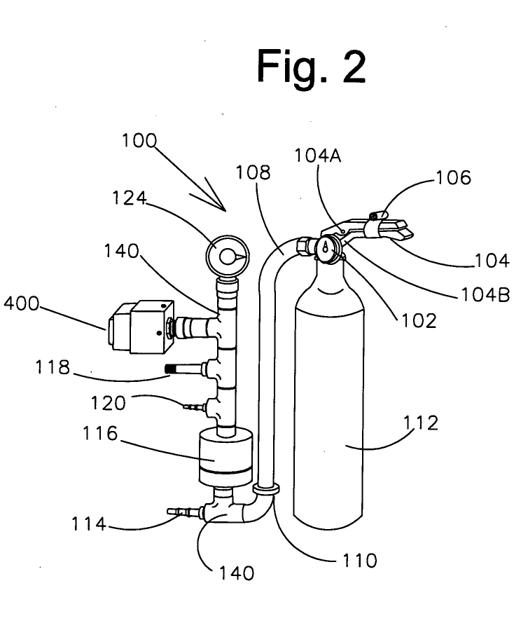

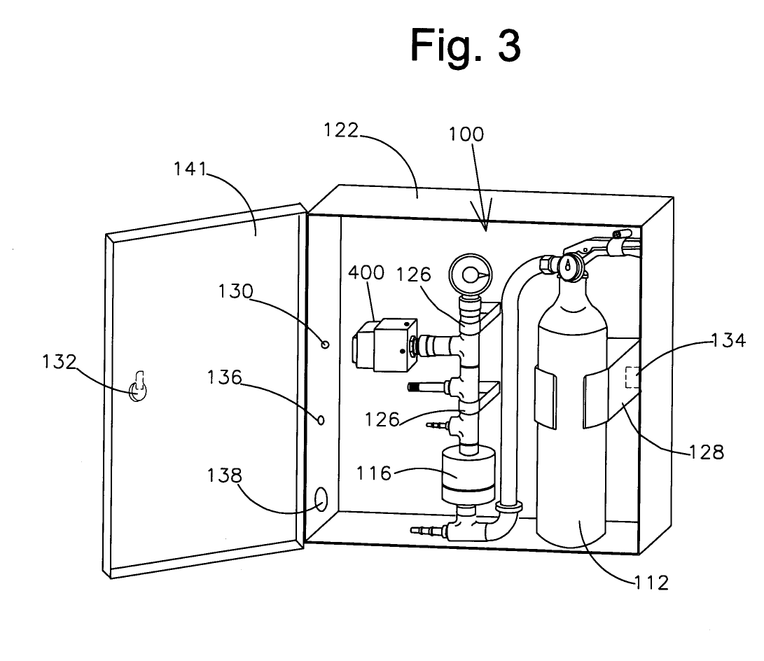

FIG. 2 illustrates a control unit 100 while FIG. 3 illustrates a control unit as it would normally be housed in a cabinet 122. The said control unit includes a vessel 112 under pressure and containing fire suppressant.

The said vessel 112 is initially installed with full design pressure as indicated with pressure gauge 102. When placing the system in operation after installation and verifying its integrity, the fire suppressant release lever 104A is depressed against the fixed device 104 and permanently locking an internal valve in an open condition by applying a locking device 106 which will sufficiently hold the internal valve of the vessel 104B in a potentially dischargeable condition.

The said vessel is in communication with the said suppressant system by hose or pipe 108 through a connector 110 to piping connecting to a connection device for hose or piping 114 allowing passage of gas propellant from said vessel to the said thermally actuated spray head 500 through said hose or piping FIG. 1 and FIG. 2.

Pressure within the said vessel also feeds through connecting piping 140 through a conventional in line filter 116 to a hose barb or connector 120 to apply pressure to gas valve 200 FIG. 1. Said pressure also is applied through said connecting piping to the pressure operated alarm monitoring switch 400 and to a pressure gauge 124 whose purpose is for initial leak detection and setup operation with the initial gas for testing being induced through valve stem 118 prior to opening said valve 104B.

A cabinet 122 FIG. 3 constructed of material adequate for the purpose provides restraining strapping 128 for restricting movement of the said suppressant vessel. Additional restraining devices 126 hold the companion piping and devices in a restrained and vertical position to limit the effect of any powdery suppressant that may pass through the filter 116.

Said cabinet 122 shall include a cover with a means of holding the cover in a closed position with the aid of latching device 132 engaging another cabinet mounted device 134 to hold said cover in a closed position when not being serviced. A penetration 138 is provided within the said cabinet for connection of the fire suppressant discharge hose or piping 28 FIG. 1 and FIG. 2 and another penetration is provided for the pressure line 34 FIG. 1. An additional penetration 130 FIG. 3 is provided for installing an alarm monitoring cable for connection to the said alarm monitoring switch 400.

The said extinguishing unit can be placed in kitchen cabinets 24, as shown in FIG. 1 or can also be mounted in any other convenient space such as an adjoining room or even an attic space with reasonable access provided such location is within a predetermined maximum distance provided through engineering calculations that is adequate for transmission of the fire suppressant by means of the high pressure hose or piping 28 FIG. 1.

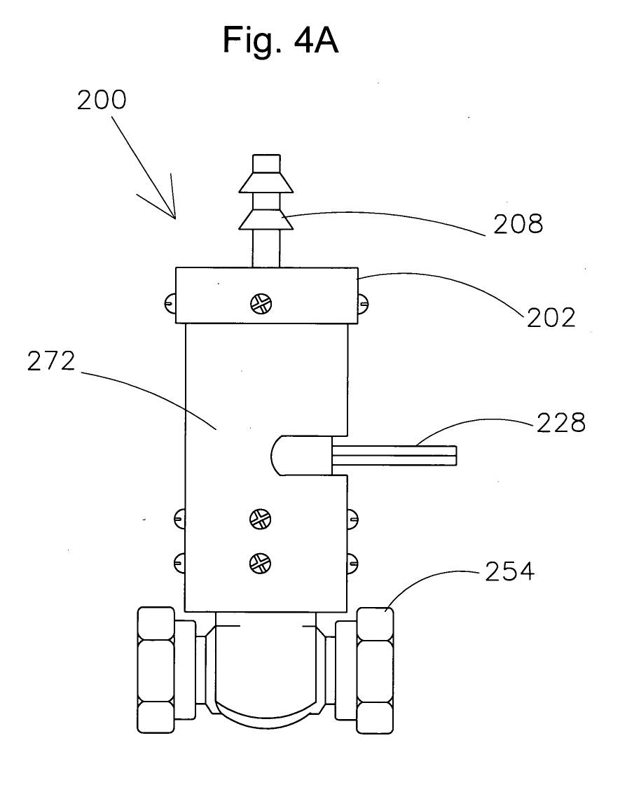

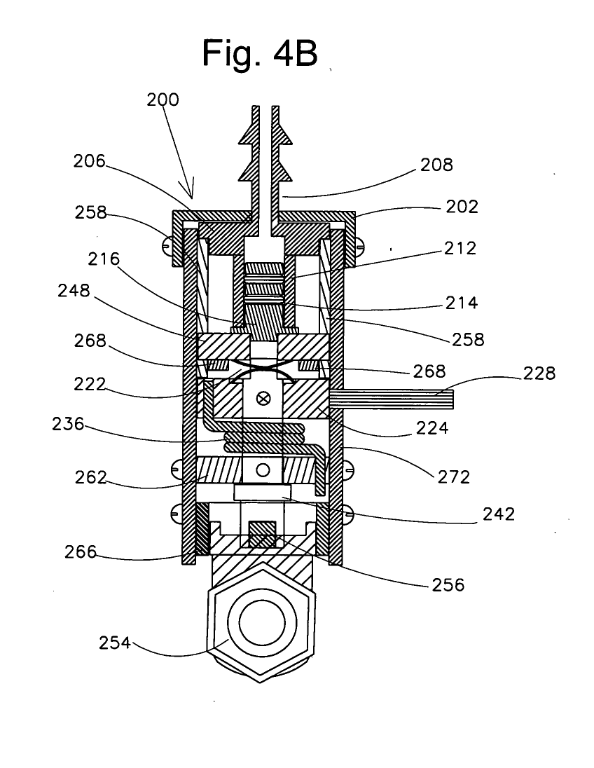

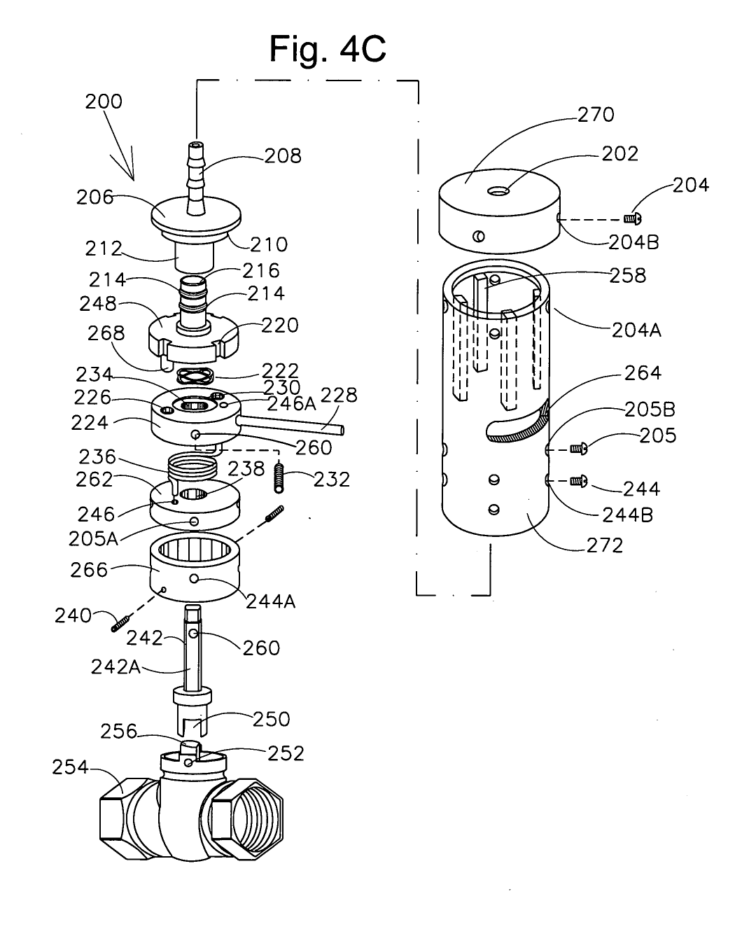

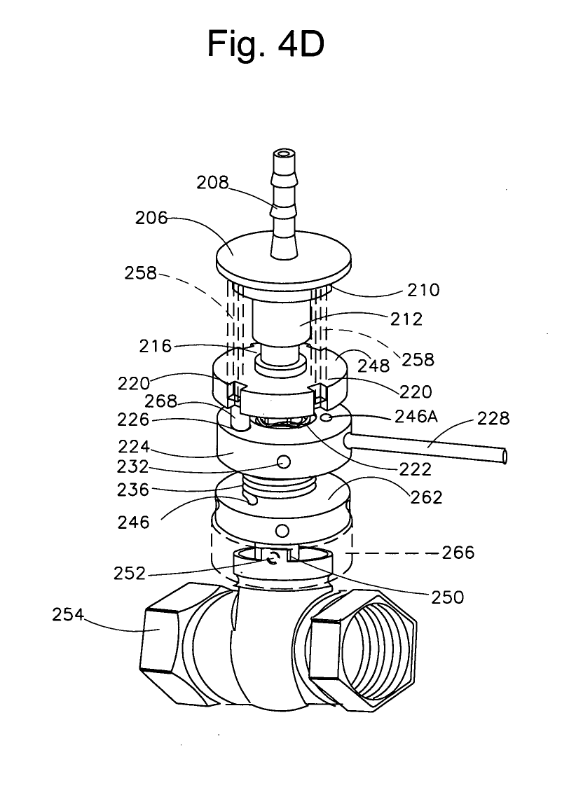

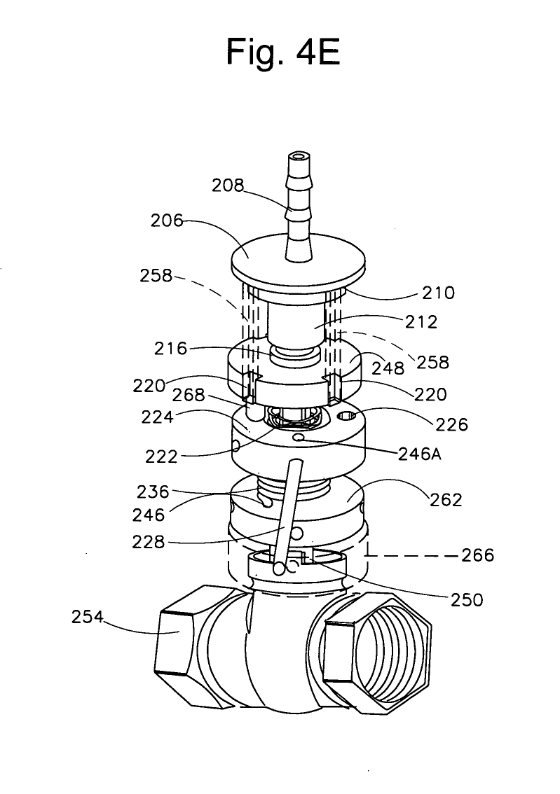

A pressure operated gas valve 200 as shown in FIG. 1 is shown in detail in the following FIG. 4A through FIG. 4E and is designed to operate with in the totally pressurized system previously described and is designed to provide a convenient and easily installed device for interrupting gas flow to a cooking stove in the event of a fire and in which the extinguishing system is operated. Other methods of operating the said gas valve within a pressurized system are possible but the method portrayed here is what is presently preferred.

The side view of the valve operator case 272 with cap 202 and gas valve 254 FIG. 4A displays its outside appearance and includes a hose barb or connector 208 for receiving gas pressure from the control unit 100. A cocking lever 228 is provided to initially cock the said gas valve in an open position to pass cooking gas energy to a gas stove 40 FIG. 1. Gas pressure from the said control unit 100 FIG. 2 is induced into the said hose barb or connector and the said valve can then be locked in the open position. When the gas pressure from the said control unit is sufficiently reduced, the mechanism of the said pressure operated gas valve will operate to close the valve and the said cocking lever 228 will rapidly swing in a position as to close the said valve 254.

A cross sectional view is shown in FIG. 4B. The case 272 provides support for components; valve adaptor ring 266 and spring base disk 262, while providing guidance for the piston operating disk 248. In viewing FIG. 4B cross sectional drawing and FIG. 4C exploded view it can be seen that a valve extension shaft 242 with a female slot 250 fits snugly around the valve stem 256. Said valve is fitted with an adaptor ring 266 which is locked in place around the top of said valve with two locking set screws 240 set in threaded holes and engaging two unthreaded holes 252 in said gas valve. The said valve operator case then fits to the said adaptor ring and is secured by screws 244 into holes 244B and to threaded holes 244A in said adaptor ring thereby providing a ridged mount for other components.

Said spring base disk 262 harbors a smooth round hole 238 which does not restrict the turning of said valve extension shaft. Said spring base disk is locked rigidly to the said valve operator case with screws 205 penetrating said case through holes 205B and engaging threaded holes 205A in said spring base disk.

A torsion spring 236 encircles said extension shaft with one end of said torsion spring located in hole 246 in said spring base disk. The opposite end of said torsion spring is inserted in cocking disk 224 through spring retainer hole 246A. Said cocking disk has a formed slot 234 that fits the flattened surface 242A of the said partially rounded valve extension shaft. Said partially flattened surface engages the said formed slot of the said cocking disk. Said cocking disk is locked to said valve extension shaft by set screw 232 fitted to threaded hole 260. A cocking shaft 228 extends through said valve operator case through cocking shaft slot 264 and is installed in said cocking disk for the purpose of rotating said cocking disk through a predetermined arc.

A depression 230 is formed in said cocking disk surface to harbor a wave spring 222. Holes 226 of sufficient diameter and depth are formed in said cocking disk for the purpose of engaging locking pins 268 permanently mounted in the piston operating disk 248. Said piston operating disk includes a piston 216 with two rubber o-rings 214 for the purpose of sealing the piston against the side of the cylinder 212 against gas pressure forced against it but still allowing movement of the said piston within the said cylinder. The said piston operating disk contains four follower channels 220 which engage piston guide screeds 258 which are internal too and a part of the valve operator case 272 which allows the said piston operating disk to move both up and down but restricts any rotating movement.

Said piston fits within a cylinder 212 which is part of a top piece 206 which rests against the top of said piston guide screeds and with detent 210 fitting inside said piston guide screeds. The said top piece also includes a hose barb or connector 208 which receives and passes pressurized gas to said cylinder 212.

Said top piece is held within the said valve operator case by a cap 202 which fits over the top of said valve operator case and is secured by screws 204 inserted through holes 204B which fit into threaded holes 204A of said valve operator case. Said cap also includes a hole 270 for accommodating the protruding said hose barb or connector 208.

FIG. 4E and FIG. 4D perspective drawings portray the valve operating mechanism without the valve operator case 272 and the valve adaptor ring 266 is shown by dotted lines to expose the said valve extension shaft engaging the said valve stem. FIG. 4E displays the gas valve 254 in the closed position with no gas pressure on the cylinder 212 and the piston 216 attached to the piston operating disk 248 is in its most relaxed position urged by the wave spring 222 pressing on the upper surface of the cocking disk 224 and said piston operating disk under surface. The torsion spring 236 applies sufficient force in a clockwise direction as viewed from above to forestall any movement. The cocking shaft 228 is restrained in any further clockwise movement by the cocking shaft slot 264 FIG. 4C.

When sufficient gas pressure is supplied to the hose barb or connector 208 by the control unit 100 FIG. 2 the gas is induced within the cylinder 212 and urges the piston to move against and overcoming the opposing force of the wave spring 222. The said piston operating disk 248 can only move in a downward direction restrained from any lateral movement by the piston guide screeds 258 sliding within the follower channels 220 of the said piston operating disk. Pressure is then placed on locking pins 268 projecting from said piston operating disk pressing against the smooth top surface of the said cocking disk. When the said cocking shaft 228 is manually urged in a 90 degree arc counter clockwise as viewed from above the said locking pins will find and drop into recesses 226 engaging the attached said piston operating disk to follow thereby causing the said cocking disk to be restrained in a locked non rotating condition. Since the said valve extension shaft 242 is attached to the said cocking disk and therefore the said gas valve operator shaft valve stem 256 the gas valve is then locked open to allow passage of the heating gas to the said stove.

Release of the gas pressure supplied to the said cylinder 212 will then cause the said piston operating disk to be retracted by the urging of said wave spring thereby separating the said locking pins of the said piston operating disk from the said recesses 226 thereby releasing said cocking disk and urging the said valve to be closed by the stored energy of the torsion spring 236.

The fire protection system of this invention can utilize a multitude of conventional thermally actuated spray heads of several vendors to be selected according to the space to be covered with the fire suppressant.

### Advantages

From the description above, a number of advantages of my kitchen type fire protection system become evident and these advantages are:

(a) the control unit cabinet that houses the suppressant vessel and provides the pressurized fire suppressant does not require extensive installation and can be placed in any number of locations in the near vicinity of the protected area. This unit provides a means of checking the system prior to placing the system in service;

(b) the system can be installed in instances either with or without a range hood;

(c) all components will be out of the view of persons near the stove except for one or more small thermally actuated spray heads. Collection of grease and dust on the operating components is severely minimized in comparison with others. Systems as described earlier have much of their equipment easily seen which detracts from the appearance of the kitchen and the pipes and wires are exposed for the collection of grease and dirt;

(d) installation of the gas disconnect to the stove to remove the source of the heat to the stove is by simple screw on valve that would be installed after a building code required manual gas cut off valve. Installation of tubing or piping to this device for operation of the disconnect utilizes only a small tube easily installed even to pulling the said tubing or piping inside a wall;

(e) connection of the thermally activated spray head to the control unit is by means of flexible hose or by piping;

(f) a very important feature of this invention is that it is continually pressurized and failure of the system such as a leak in the two hoses or piping will cause interruption of the gas to the stove therefore making it fail safe;

(g) due to the simplicity of the installation the cost of this system for gas stoves should be well within the average home owners' affordability.

### CONCLUSIONS, RAMIFICATIONS, AND SCOPE

Thus the reader will see that the fire extinguishing system presented herein provides a highly reliable, easily installed system that can save property and lives.

While the above description contains much specificity, these should not be construed as limitation on the scope of the invention, but rather as an exemplification of the preferred embodiment thereof. Many other variations are possible. As an example, the system can be installed as a protective system in confined instrument cabinets or in many other such applications where fire and the cut off of gas are imperative.

The operational design of the equipment as presented herein is the presently preferred embodiments and variations of the basic designs might well result in future cost savings. As example, the cocking mechanism of the gas valve could be changed to a ratchet type mechanism or the unit could be self restoring upon the resumption of the pressurized propelling gas of the extinguishing system. However, the simplicity of installation and the fail safe nature of the system are the main attributes.

Accordingly, the scope of the invention should be determined not by the embodiments illustrated, but by the appended claims and their legal equivalents.

For all of the above reasons, applicants submit that the specification and claims are now in proper form, and that the claims all define patentability over the prior art. Therefore they submit that this application is now in condition for allowance, which action they respectfully solicit.

1. A system for extinguishing cooking stove fires comprising:
(a) at least one thermally actuated spray head located above the cooking stove and
(b) means for disconnecting cooking gas to the cooking stove and
(c) a vessel containing inert gas under pressure with a fire extinguishing agent and being in fluid communication with at least one thermally activated spray head and cooking gas disconnect means and wherein activation of the spray head activates the cooking gas disconnect means so as to disconnect cooking gas to said cooking stove.

2. The fire extinguishing system according to claim 1 wherein the cooking gas disconnect means further comprises:
(a) a gas valve mechanism with means for being inserted between the supply of flammable gas and a cooking stove gas input means and
(b) a mechanism operating within the said gas valve has means for receiving inert gas pressure as from the said extinguishment vessel for activating an internal latching means and
(c) the mechanism includes a manual reset means for restoring the operation of the mechanism when the said valve is in a shut off mode for resumption of cooking gas flow when sufficient pneumatic pressure is induced and
(d) operation of the said manual reset means when sufficient pneumatic pressure is present will cause the latching of the mechanism thereby allowing continual cooking gas flow capability to the said cooking stove and
(e) in the event of lowering pneumatic pressure below a predetermined pressure will cause the release of the said latch thereby causing the immediate interruption of the flow of cooking gas to the said cooking stove.

3. The fire extinguishing system according to claim 1 wherein the actuating means comprises a pneumatically operated piston.
